(19) United States
(12) Patent Application Publication
(10) Pub. No.: US 2009/0204260 A1
(43) Pub. Date: Aug. 13, 2009

(54) Door Opener Arrangement for Use with an Industrial Robot

(75) Inventors: Gisle Bryne, Tokyo (JP); Ole Arnt Anfindsen, Sandnes (NO)

Correspondence Address: VENABLE LLP, P.O. BOX 34385, WASHINGTON, DC, 20043-9998, US

(73) Assignee: ABB AS, Billingstad (NO)

(21) Appl. No.: 11/664,264

(22) PCT Filed: Sep. 30, 2004
(86) PCT No.: PCT/IB04/03177

§ 371 Date: Oct. 6, 2008

(51) Int. Cl. B25J 13/08; B25J 19/04; G05D 7/06

(52) U.S. Cl. 700/259; 901/47; 700/283; 901/9; 901/43

(57) ABSTRACT

A door opener arrangement for a robot coating device, used for detecting a position of a part (6) of a door (7) so that the door can be opened and/or closed for interior painting. The door opener is arranged with at least one non-contact sensor member (1), preferably for detecting changes in a field strength of a magnetic or electromagnetic field in a Z and vertical direction, and may be arranged with a plurality of sensors to detect a collision etc. A method, system and computer program are also described.

### TECHNICAL FIELD

The present invention concerns a door opener arrangement for use with an industrial robot. The invention relates to a door opener with a new sensor arrangement for robotic and highly automated production applications, and use of the industrial robot with the door opener. The arrangement is particular advantageous for painting or other coating operations for vehicle bodies.

### TECHNICAL BACKGROUND

Industrial robots are used extensively and successfully for automated paint spraying and other coating operations. Automated coating of automobile exteriors is well established. However, automation of interior painting on automotive lines is limited today. It is for example difficult in practice to sense the location of the object to be painted. This problem is made more difficult when painting a vehicle on a continuously moving production line, as compared to stopped or stop-and-go lines. For moving line automated solutions a significant problem also arises concerning how to deal with unplanned production stops. This is because there is in practice a significant lag between the position sensor used by the robot and the actual position of the vehicle body. This is often due to play or backlash in the long conveyor chain or other transport mechanism.

At least three approaches have been used in an attempt to overcome the problem of hard to locate vehicle bodies:

manual spraying: disadvantages of low yield, much higher paint consumption, labor cost, possible health and safety disadvantages;

mechanical fixtures that reduces the accuracy needed by adding compliance and tolerance, but increases cost and achieves below optimal process yields;

using camera systems to measure the vehicle body position before starting the process, with disadvantages of high investment cost and system complexity, frequent maintenance, and usually with a disadvantage of not being able to detect the position of the door after opening the door.

U.S. Pat. No. 4,498,414 to Mazda Motor Corporation, entitled “Vehicle body painting robot”, describes a robot comprising a painting arm for coating paint on a vehicle body which is transferred along a conveyor line. The robot painting arm is further equipped with a door opener, and a door sensor for sensing the position of a window lifter groove of a door. The door sensor described is a non-contact sensor that detects the window groove by measuring a time taken for reflection of an ultrasonic wave from the bottom of the window groove. A disadvantage of this method is that ultrasonic sensors when openly exposed in the spraying area may easily become contaminated with paint and lose reliability.

Similarly U.S. Pat. No. 4,988,260 to Mazda Motor Corporation entitled “Automobile door opening/closing equipment”, describes an engaging rod fitted to the end of a coating robot arm, and an optical or ultrasonic sensor also mounted at the end of the arm in the proximity of the engaging rod. The disadvantage that such sensors are easily contaminated by paint mist requires the further addition of a shutter mechanism and air purging apparatus, as described, for preventing paint from covering the non-contact sensor. Similarly, in JP 1023559 to Suzuki, entitled “Tool for opening and closing door”, an optical sensor S, mounted in an oscillating sensor case 3, is fitted to the arm of a painting robot to detect position of the window groove of the door. The automobile door is opened by engaging a motor driven opener rod 4 in the window slot. Both the sensor and the opener rod are mounted on the painting arm of the robot, and the sensor case is oscillated and controlled so as to minimise paint mist forming on the aperture of the sensor. Failure of a door sensor or door opener arrangement can lead to production interruptions which in turn may require extensive manual intervention in order to arrange and re-set machinery and process objects so that a line may be re-started. Lost production time due to adjustments necessary before re-starting a production line after an interruption may represent a considerable source of reduced production efficiency, problems with paint coating quality, and even significant economic losses.

Further, the type of method used in U.S. Pat. No. 4,498,414 to program the robot is the method known as robot teaching, which uses the subsequent playing back of a memorized and recorded sequence of actions according to the contents of a teaching to control the operation of the robot. This method often has a disadvantage that if an unplanned stoppage occurs, the robot manipulator and/or other moving parts may stop in an unknown position. The robot then requires manual starting or “jogging” in into a known position, before the line may resume production after a stoppage without collisions etc. This causes a delay which is time consuming, often leads to considerable delay in production and may cause quality failures.

The known door opener arrangement and door sensors suffer from many disadvantages. The use of non-contact sensors according to the prior art demands complicated measures to avoid paint forming on a sensor, thus reducing reliability and requiring a great deal of maintenance and service.

### SUMMARY OF THE INVENTION

A primary aim of the present invention is to provide a door opener arrangement for an industrial robot for use in coating applications that overcomes the drawbacks of known such robot tools. A secondary aim is to provide a sensor to detect the position of a door in order for a door opener arrangement of an industrial robot to cooperate with the door. Another aim of the invention is to provide a door sensor for a door opener arrangement that comprises a non-coating or secondary or auxiliary arm arranged to cooperate with the robot.

The above and more aims are achieved according to the invention by a door opener arrangement for an industrial robot according to independent claim 1, by a method according to independent claim 17 and a system according to independent claim 29. Preferred embodiments are described in the dependent claims.

According to a first aspect of the invention these and more aims are met by the invention in the form of a robot arranged with a door opener arrangement equipped with a door sensor for non-contact measurement of distance to an object, and thereby the position of the object.

According to another aspect of the invention these aims are met by the invention in the form of a door opener equipped with a door sensor for non contact measurement of distance to an object.

According to another aspect of the invention these aims are met by the invention in the form of a door opener arrangement equipped with a door sensor for non contact measurement of distance to an object, and a one or more sensors arranged to determine application of external forces or collision forces to the door sensor or door opener.

According to another aspect of the invention these aims are met by the invention in the form of a method for detecting the position of a part of a door.

According to another aspect of the invention these aims are met by the invention in the form of a system for robot coating of vehicles comprising a a door opener arrangement for detecting a position of a part of at least one door.

The door sensor according to an aspect of the invention is a simple but accurate device for sensing the position of the object without making contact with the vehicle body. It may be combined in a door opener arrangement with a door opener that grips the door in a way that is non-destructive relative a coated surface. The door opener opens the door and holds it while spraying is carried out, or, if for example the door comprises a hinge with a built-in position-lock, the door opener releases the door and checks its position, then later checking the position again before gripping the door in order to close it. The non contact sensor is combined with force sensors for detecting any mechanical forces applied to the door sensor, or the arm of the door opener arrangement it is mounted on, so as to detect and/or avoid collision with a robot, the vehicle body or other objects.

An advantage of this solution is that it can be used on both moving and stationary objects (the door or other part of the object can be released if there is some other mechanism to hold or restrain the object in the set open position). Thus vehicles may painted using the door opener arrangement of the invention for both stop-and-go-methods and moving methods, which may also advantageously be carried out using the same conveyor or production line.

If there is no built-in position-lock mechanism, in the door hinge for example, the door or other work object normally needs to be held while carrying out the application, particularly so for a moving conveyor operation rather than stationary or stop-and-go.

The benefits of an accurate and efficient door opener arrangement include that painting operations may be carried out swiftly and accurately, with fewer paint quality problems and less maintenance required for the sensor, sensor system or door opener arrangement itself. This also leads to the benefit that re-starts from unplanned stoppages without physical human intervention becomes much more feasible, thus eliminating a major source of lost production efficiency. In addition to reducing downtime and speeding up production line changes it also eliminates the need for a person to enter the production cell or other area around a robot due to door sensor failure. A technical benefit of reliable position sensing is that of more uniform cycle times. Uniform cycle times in turn leads to more consistent variations of process parameters, thus reducing quality variation due for example to heating or cooling effects on materials used, eg paint, adhesive, sealant, primer, or even on the vehicle body itself.

In a preferred embodiment, the door opener arrangement is arranged as a second and non-coating arm of the robot. The door opener arm may be a second arm mounted on or arranged attached to the base of a painting robot. In this way, many of the problems of the prior art due to paint build up on a non-contact sensor are avoided because the sensor is not fixed beside a spray head, and the sensor may easily be moved completely out of the way of any paint mist during spraying sequences.

In a development of a preferred embodiment, the second and non-coating arm or manipulator opening the door, the door opener, may if required for the process report the exact location of the object to be painted to the coating robot or coating manipulator that carries out the painting job.

In a preferred embodiment of the invention the control unit(s) comprise one or more microprocessor units or computers. The control unit(s) comprises memory means for storing one or more computer programs that control the power transfer. Preferably a such computer program contains instructions for the processor to perform the method as mentioned above and described in more detail below. In one embodiment the computer program is provided on a computer readable carrier such as a CD ROM.

### BRIEF DESCRIPTION OF THE DRAWINGS

Embodiments of the invention will now be described, by way of example only, with particular reference to the accompanying drawings in which:

FIG. 1 is a schematic diagram for an industrial robot process cell arranged with a door opener arrangement according to an embodiment of the invention;

FIG. 2 is a schematic block diagram of communications for and control of a door opener arrangement door sensor for an industrial robot arranged with one or more door sensors;

FIG. 3a is a schematic diagram for illustrating the motion of a door sensor and FIG. 3b a schematic diagram illustrating a signal measured by a door sensor;

FIG. 4 is a diagram of signal strength versus measurement distance;

FIG. 5a is a plan view of a door opener arrangement with a door opener arm equipped with a door sensor according to another embodiment of the invention, FIG. 5b is a front elevation for the same door opener, FIG. 5c a side elevation for the door opener as viewed from the vehicle door; and FIG. 5d is a view of a robot showing a plurality of axes of movement and a system for estimating a deflection force on the robot arm;

FIG. 6a is a schematic detail diagram for force sensors of the door opener arrangement according to an embodiment of the invention, FIG. 6b is a schematic detail for a first sensor head of the door sensor; FIGS. 6c is a schematic detail for a recessed magnetic sensor and FIG. 6d is a schematic detail for recessed magnetic part for sensor;

FIG. 7 is a schematic flowchart of a method for controlling a door opener arrangement according to an embodiment of the invention;

FIG. 8 is a schematic flowchart of a method for controlling a door opener arrangement and door sensor according to an embodiment of the invention;

FIG. 9 is a schematic diagram for an industrial robot process cell arranged with two door opener arrangements according to another embodiment of the invention.

### DETAILED DESCRIPTION OF THE EMBODIMENTS

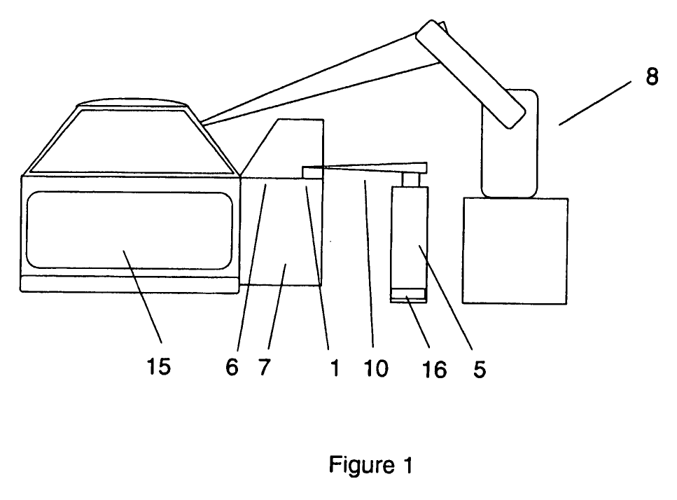

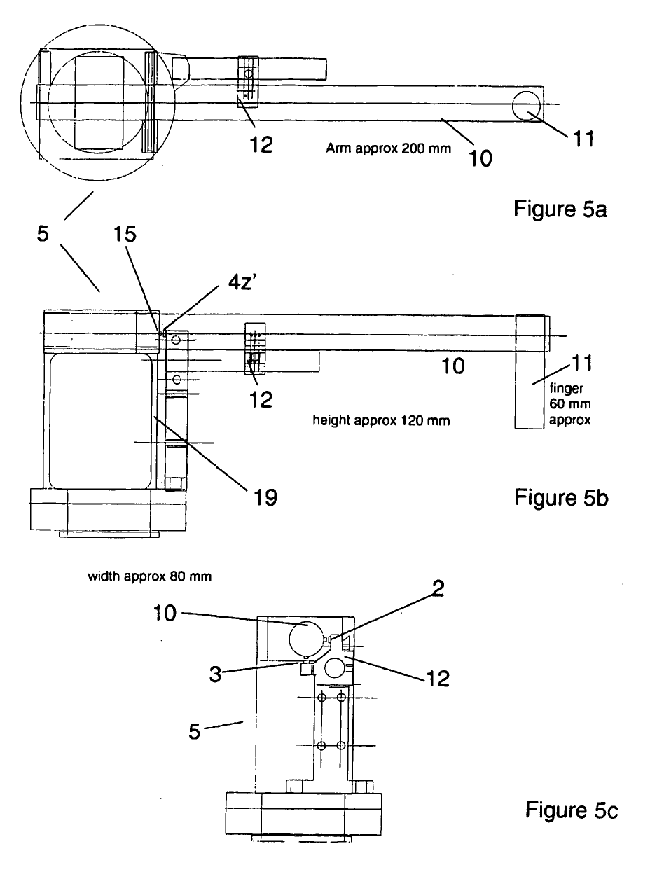

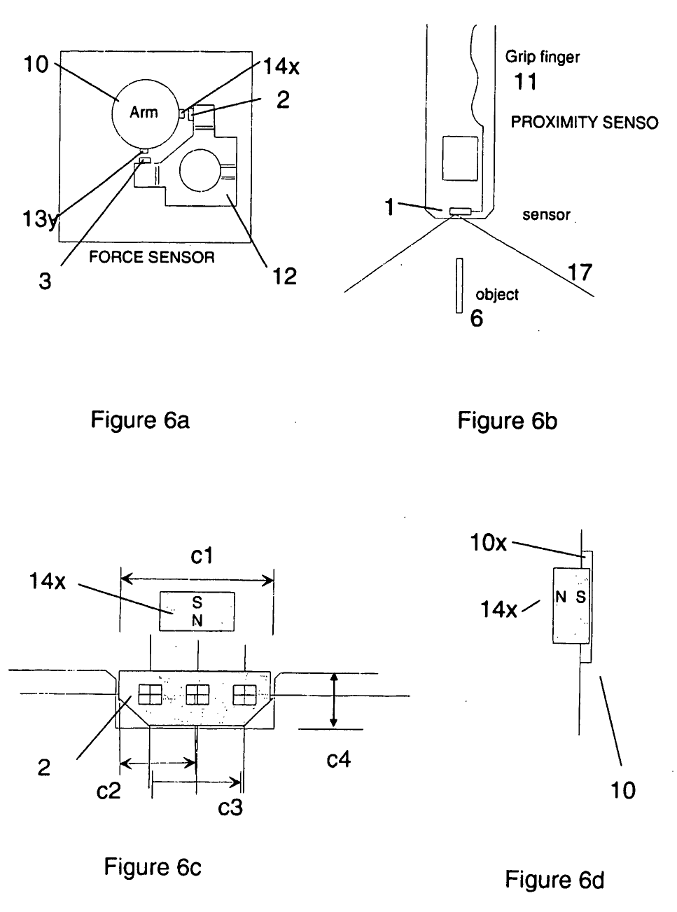

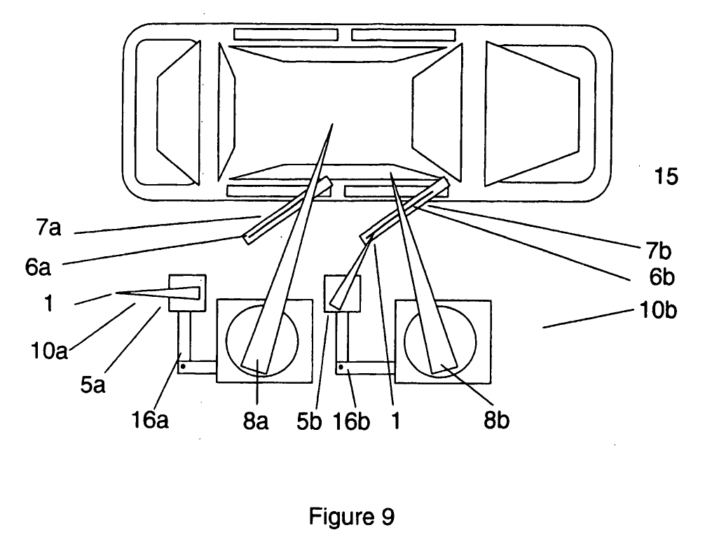

FIG. 1 shows a view from in front of a process area of a production line that includes a coating operation, such as a paint booth. FIG. 9 shows a view from above looking down on a similar coating process. FIG. 1 shows a vehicle body 15, a robot 8 comprising a first arm arranged for painting, and a second arm 10 of a moveable assembly 5, a door opener arrangement, is mounted beside the painting robot. Typically the vehicle body is moved into, through and out of the process area by a transport device such as a conveyor belt or chain or the like. The second arm 10 of the moveable assembly 5 has a non-contact sensor member 1 mounted at one end, also described in respect of FIGS. 5, 6 below. The figure further shows that the vehicle has at least one door 7a, and the position of a groove for a window 6 of door 7a is indicated. The window groove 6 is the exemplary target for a door opener to insert a rod, claw or finger with which to take hold of the door and open it or close it. The line operation may be one of moving, or continuous movement, or stop-and-go, in which the vehicle is moved into the area, stops, is painted, and is subsequently moved out of the area after painting.

As shown in FIG. 9, the door opener arrangement comprises at least one non-contact sensor member 1 mounted at the end of an arm 10 (10a, 10b of FIG. 9) which is part of an assembly 5 that is moveable in more than one axis direction. The door opener assembly 5 may be moved by an arm or linkage 16. The door sensor 1 senses the position of the window groove 6 so that a finger 11 (shown in FIGS. 5, 6 in more detail) may be inserted in the window groove and the door gripped and moved by the arm 10 that the grip finger 11 is attached to. It may be noted from FIGS. 1 and 9 that the arm 10, 10a, 10b of the moveably assembly 5 is a separate arm to the manipulator arm of the coating robot 8a or 8b (FIG. 9). In contrast to door openers and door sensors of the prior art the door opener arrangement of the present invention is best embodied as a second moveable arm 10, or multi-axis manipulator, that is arranged separately from a first robot arm that carries out the actual paint spraying. Thus the door sensor of the door opener arrangement does not have to be in the vicinity of the paint spray head of the robot at any time when the paint spraying takes place. The great majority of paint mist contamination on the non-contact sensor is eliminated in this way by the invention. The robot may also have two or more spray heads fitted to the same manipulator arm, pointed for example in different directions in order to coat big objects or objects with multiple or awkward shapes. A door opener and door sensor arrangement may also be arranged to open and/or close a door or similar for coating by other program controlled coating machines, such as a reciprocator.

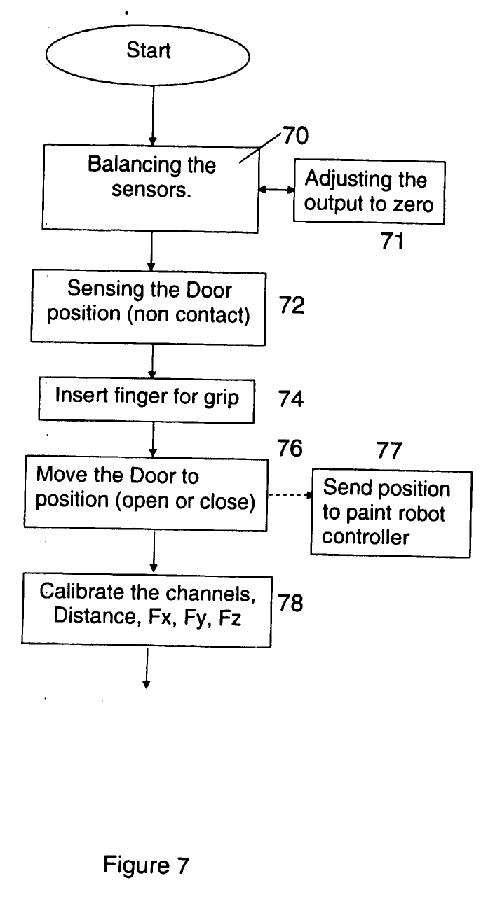

FIG. 7 shows steps of a method according to the invention for operating the door opener arrangement control program, and instructions for controlling a door opener. The method begins with balancing 70 the sensor outputs, by for example setting outputs to zero 71, or other method suitable for force deflection calibration. The. sensor values are then sampled in order to determine the door position 72 while the door sensor 1 assembly is moved along a path towards the door, and in particular, towards the target—normally the window groove 6 (FIGS. 1, 6b, 9). The door position is sensed, without physical contact 72 and the finger 11 is inserted 74 to grip the door for opening and/or closing. The door is moved 76 to a predetermined position, which optionally may be signaled 77 to a controller controlling the painting arm of a robot. While the door sensor is moved the force deflection sensors 2, 3, 4 are sampled so that any collision beginning or taking place may be detected, and suitable measures taken. At end of movement the four input channels for distance and deflection forces in X, Y and Z directions are calibrated 78 again.

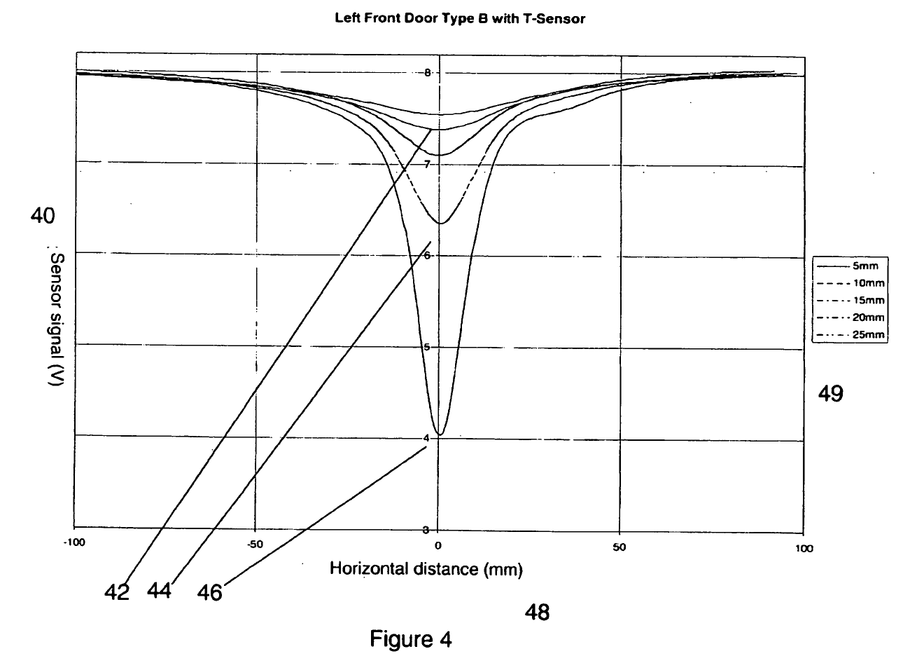

FIG. 4 shows a diagram of signal strength 40 from the non-contact sensor 1 versus horizontal distance 48 from the target, in this case the window groove 6 of FIG. 1. It may be seen from the plot that a distinct change in signal voltage, a peak or inflection (42, 44, 46), appears when the sensor is above the region of the open hole, the window groove, in the door. The change in voltage due to changes in magnetic or electromagnetic field strength is more distinct when the sensor is closer to the window grove, solid line 46 at 5 mm distance above window height, as compared to farther away, 42 at 25 mm. Thus the door sensor may be used to detect the position of a change in shape, especially a hole or aperture in a metal plate, like the window groove, or alternatively any other selected hole, hook or aperture, such as place for example to accept a lock, latch, filler cap or door-handle assembly etc.

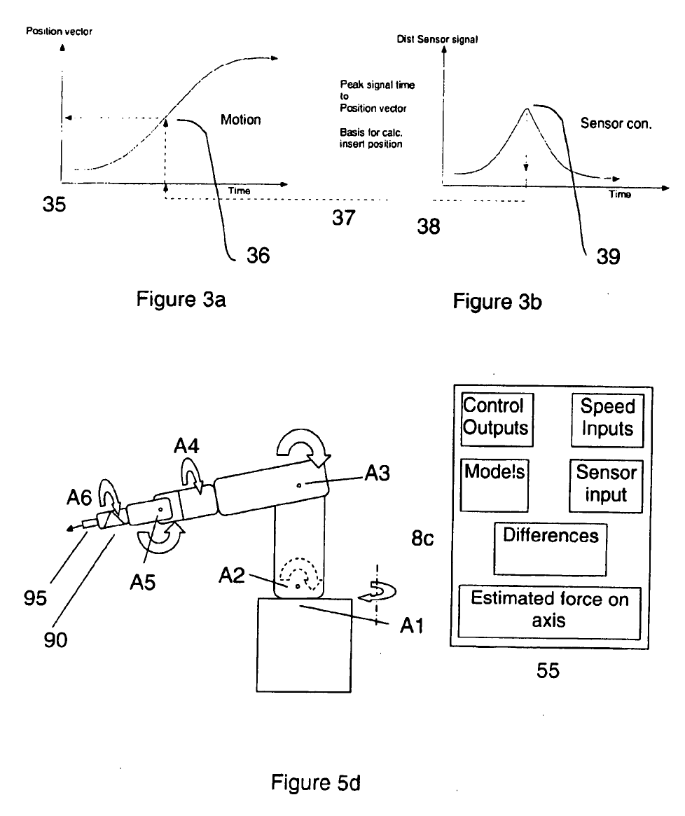

FIGS. 3a and 3b show diagrams of measurements that are used to determine and/or calculate the position of the window groove. FIG. 3a shows a diagram of the travel movement 35 of the door sensor with respect to time, and a point 36 on the resultant curve. FIG. 3b shows the non-contact sensor signal 38 against time with an inflection point 39 which corresponds to the mid-position, centre, of the window groove 6 opening. A time point 37 in both FIGS. 3a and 3b is shown as the ideal time to insert the door opener finger 11 to grip the door.

The door opener arrangement also comprises force deflection sensors as noted above in respect of FIG. 7, or other means to provide a value for applied force. The force deflection sensors are used to detect force or forces applied to the sensor 1 unit, finger 11 or the door opener arm 10 as may occur due to an unplanned movement, position or a collision. FIG. 5a shows the door opener assembly 5 seen from above looking down, with an arm 10, and the position of a force sensor assembly 12 indicated on one part of the arm and of the grip finger 11 indicated near the end of the arm. FIG. 5b shows the same door opener assembly 5 from the side. The grip finger 11 is fixed to and descends from the arm 10, and has the non contact-sensor 1 inside (not shown in FIG. 5b, see FIG. 6b) preferably arranged in a recess, cavity, or the like. Force deflection sensors are arranged about the arm 10. A sensor assembly 12 may be seen arranged to cooperate with arm 10. A force deflection sensor 4z′ is indicated arranged fastened to the arm 10 so as to sense a magnetic member 15 attached to a part of the tower 19 assembly of the door opener assembly 5. Deflection of the arm 10 in a vertical z direction is sensed by field strength changes at sensor 4z′ if the air gap between magnetic member 15 on the assembly tower and sensor 4z′ changes.

FIG. 5c shows the door opener assembly 5 looking from the grip finger end of the arm where the sensor is fitted towards the tower 19. The Figure shows the sensor assembly 12 arranged on the arm with two deflection sensors 2, 3 arranged facing magnetic members 14x and 13y (see FIG. 6a) attached to the arm 10. Deflection of the arm 10 in an x-horizontal direction in a plane perpendicular to the direction of travel of the door opener is sensed by field strength changes at sensor 2 if the air gap between magnetic member 14x on the arm 10 and sensor 2 changes. Likewise sensor 3 is arranged opposite a magnet or magnetic member attached to the arm 10 to sense changes due to deflection of arm 10 in a direction at right angles to the above x-direction in the same plane, perpendicular to the direction of travel of the door opener and/or the long axis of the arm 10.

FIG. 6b shows details of the non contact sensor 1 and the grip finger 11. Grip finger 11 is mounted towards the end of the arm 10 of the door opener assembly 5 and is arranged with the non-contact sensor 1. The sensor is preferably but not exclusively arranged inside a hollow finger member, so that the exposure of the sensor is limited to a restricted view only, downward in this embodiment. This reduces the direct physical exposure of the sensor to other objects and to dirt or paint mist. The sensor has a substantially cone-shaped field of view 17. In this embodiment the sensor is moved in a direction lying in a horizontal plane until it is vertically above the target object 6, the window groove, at which point it senses the inflection 44, 46 etc in field strength. If necessary, the grip finger may be arranged with an air hose or similar to deliver an air blast or air curtain to prevent any dust or paint etc. from entering the grip finger 11 and contaminating the non-contact sensor.

The grip finger may be embodied in a T-shaped tool, in which two grip fingers each substantially the same as grip finger 11 of FIG. 5b are mounted opposite each other, one on either side of a rotatable shaft of the door opener arm, and where at least one of the fingers comprises a non-contact sensor in a recess. The T-shaped grip finger(s) comprising a non-contact sensor may be arranged with an air curtain or similar protection for the sensor.

Thus the door opener arrangement comprises both a position sensor or proximity sensor 1 and a number of force or deflection sensors, 2, 3, 4z′ and/or a soft sensor 55 described in more detail below. As the first non-contact sensor 1 senses in the z vertical direction, the vertical force sensor is denoted with z′ as in 4z′.

FIGS. 6c and 6d show details of the sensors used for force deflection sensing and of the co-operating magnets or other magnetic members. FIG. 6c shows a detail of the force sensor assembly 12, FIG. 6a, and in particular of the sensor 2 and of the co-operating magnet 14x attached to the arm 10 of the door opener. Sensor 2 is shown in FIG. 6c to be recessed to a depth c4 equal to the sensor thickness. Sensor 2 faces the magnet 14x which is glued or otherwise fixed in place, preferably in a precision-made recess or guide form 10x, so that it is positioned optimally opposite the sensor. Sensor 3 on the sensor assembly 12 and arm 10, and the vertical force sensor 4z′ (FIG. 5b) and tower 19 of door opener assembly 5 are preferably mounted in a similar way so that signal strength and sensitivity are optimised.

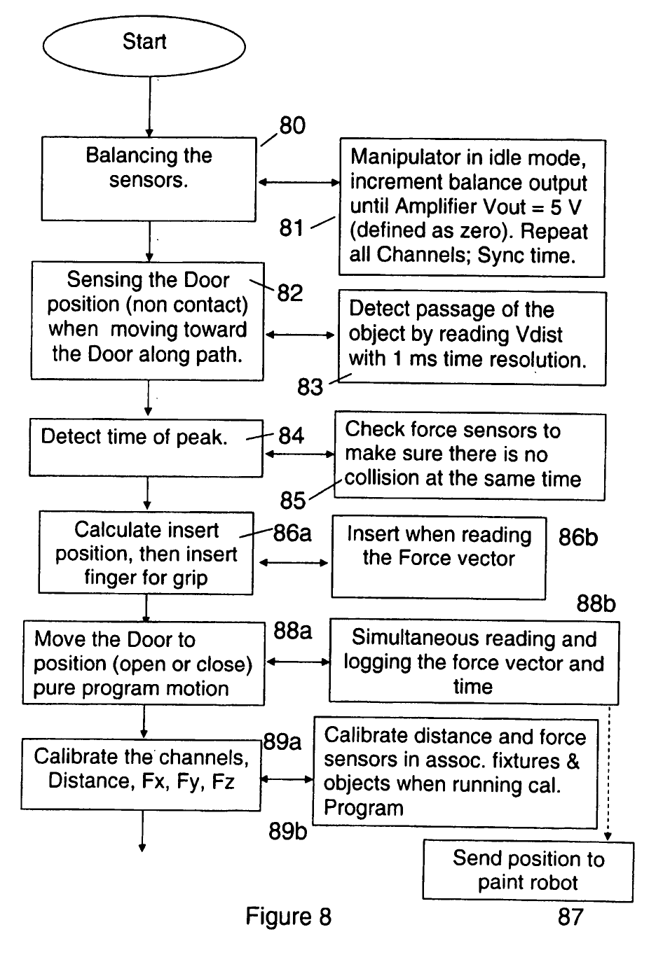

The method for finding a position of the door and gripping the door may comprise more actions or steps than those described in relation to FIG. 7. FIG. 8 shows another flowchart for steps of finding a position of a door with a non-contact sensor, and opening the door with the door opener arrangement. The method may begin at 80 Balancing mode: in more detail 81 the robot manipulator of the coating robot is in idle mode, balance outputs are incremented until Amplifier Vout=5 V (defined as zero). This is repeated for all Channels (eg 16 channels); and time for each unit is synchronized.

At 82 Sensing the Door Position begins and at the same time the door sensor and door opener is moved 83 toward the Door in an appropriate path. The distance is measured, Vdist preferably with a time resolution of 1 ms, and passage of the object detected by the value of the non-contact sensor signal reading. At 84, the time of sensor signal peak is detected. During this time, the force sensor readings are checked 85 to make sure there is no collision.

At 86a a calculation is made to determine the insert position, and the grip finger 11 is inserted 86b while force vector readings continue.

At 88a the door is moved to the desired position, pure program motion, and simultaneously reading 88b and logging the force vector and time.

At 87, which may be at any stage following stages 82, or 88a or 88b, the door position is sent to the paint robot or robot controller so that the robot operations may be controlled on the basis of the current position, accurately determined by the door opener arrangement. Vehicle position determined by, for example, conveyor position or vehicle carrier position is frequently not particularly accurate.

At 89a the channels, distance and force vectors are calibrated again.

In a development of the method, at action 86b insertion of the grip finger, the insert path may be adapted according to predetermined values for the simultaneous force reading. In another development at the calibration stage 89a the distance and force sensors in associated fixtures and objects may also be calibrated when running an advanced version of the calibration program.

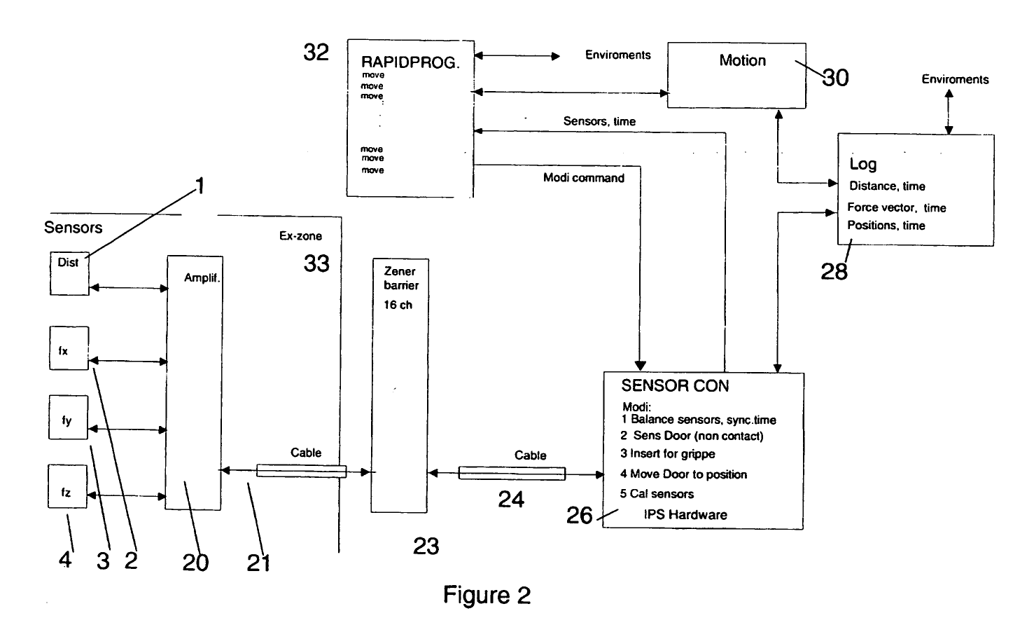

FIG. 2 shows a block diagram for functions and relationships of the method for finding the distance to the door (position) and for determining any forces applied to the door sensor or door opener arm. The figure shows an explosion-proof (EX) zone 33 within which all components must be arranged in an explosion-proof way. The non-contact (position) distance sensor 1, and force sensors 2, 3, 4 are positioned in this EX zone. The sensor signals are handled by an amplifier 20 and transmitted out of the EX-zone by cable 21 to a 16 channel Zener barrier 23. Signals are transmitted further by a second cable 24 to a control unit 26 for the sensors, Sensor Con. The figure shows that the sensor control unit is connect to a programming unit, Rapid Prog 32, to a Motion unit 30, and to a Log 28. The Sensor Con unit handles the operations of the door sensor, the non-contact position (distance) sensor, the force sensors, balancing, grip finger insertion, move door, and calibration of sensors.

The 4 sensors have two functions:

a) Contactless measuring the door position for localisation of the catch or grip position.

b) Force measurement of Fx Fy Fz (in a plane perpendicular to the long axis arm 10, and direction of travel), measurement of any forces applied to the door sensor or arm 10 when manipulating the door or the other object, or when inserting the grip. The proximity sensor may have a sensing cone in -z direction (downwards), and working distance may be from 5 to 20 mm or so with a typical work distance of 10 mm. While searching for the door, finding the position of the window groove, the time when closest to the sensing point on the door is registered during the door searching function. See also FIGS. 3a, 3b which illustrate the interaction or cooperation between position (distance) measurement and force measurement.

The necessary offset for the grip position has to be calculated depending on the shape and form of the object to be moved and the size of the sensing finger 11. This is designed to be configurable and re-configurable. If the position in Z is found to be uncertain, a search strategy for passing the door with greater distance repeating the passage at a lesser distance may be adopted, i.e. by closing-in the passages until the detection of the peak 39 of FIG. 3b is sufficiently clear to detect a precise top.

With the 3D force vector a closed loop may be created with “Motion” at the moment of grip or at the handling of the object to be moved. This may be done in order to increase the operation safety and the handling quality.

In another preferred embodiment a non contact sensor 1 comprising a detector for an electric field, or changes in an electric field, such as an inductive or a capacitive sensor, may also be used.

In yet another preferred embodiment the non contact sensor 1 of the door sensor may alternatively be an ultrasound detector, or a photoelectric, CCD, laser or IR or other optical-based detector instead of an electromagnetic-based detector. One or more of the non-contact sensors may be equipped with means such as an air curtain, air puffer or similar to protect them from being affected by paint mist or dirt or other contaminants and so on. Such non-contact sensors may be preferred when handling vehicle bodies or parts thereof that are made from non-ferromagnetic materials such as aluminum, or from non-conductive materials such as plastics from fibre-glass or other composites.

In another preferred embodiment deflection forces are estimated. FIG. 5d shows schematically a soft sensor system for estimating a deflection force exerted on the robot. The figure shows a robot 8c with several axes of movement A1-A6. The robot is shown with a sprayer or applicator head 95 and a robot wrist 90, preferably a hollow wrist of the type manufactured by ABB. A soft sensor system 55 is shown comprising values for Control Outputs, Speed Inputs, Sensor Input and Models. Differences are found between a planned or modeled motor torque or speed expected from a Control Output signal to a motor, and a measured speed or torque Input from the respective axis A1-A6, and/or loads from one or more sensor inputs to the robot. Deflection forces on the robot or forces on the robot tool are estimated by determining any differences between the planned or modeled movement and/or torques in the given axis and direction and calculating the magnitude of such an unplanned resistance in a given axis movement, due to interference or collision with the door opener arm (or vehicle). The soft sensor system may be embodied using methods and/or systems or part systems according to a soft sensor servo system described in an ABB PCT application SE2004/000790, which said document is hereby included in its entirety by means of this reference; or systems or part systems according to a soft servo system described in a patent U.S. Pat. No. 6,477,445. Alternatively a version of a soft sensor system may also or instead be applied to actuators operating the door opener arm, and/or the linkage 16 of that arm, using a soft sensor of the system 55 type (described above) in conjunction with the door opener arm to detect deflection forces exerted upon it by the robot (or vehicle). The soft sensor outputs of determined force may also be supplied together with or instead of inputs from sensors 2, 3, and/or 4 in FIGS. 2, 8.

In another preferred embodiment the door opener assembly 5 is arranged attached to a common structure, which as indicated in FIG. 9 may be link 16 between the door opener and the robot base. There may alternatively be a common platform on which one or more of the paint robots are mounted. Linking the bases of the door opener and the robot in some way is preferable because the movements of the door opener and the robot arm that carries out the painting have to be coordinated with respect to each other.

FIG. 9 shows schematically two robots 8a, 8b, and two door opener assemblies 5a, 5b. Each door opener assembly is moveably mounted preferably on a common platform upon which the robots are arranged, or for example arranged mechanically attached in another way. to the same base structure that the robots 8a and 8b are mounted on. By mounting the door opener assembly and the robot in a fixed position relative each other mechanical coordination and position calibration for the door opener arm relative the robot painting arm is greatly simplified, and calibration almost eliminated. The figure shows each door opener assembly 5a, 5b attached by a link 16a, 16b to the base of each robot, 8a, 8b.

In another embodiment the common structure holding a paint robot 8 and a door opener may be rail-mounted on a wall of the paint booth or process area. In another embodiment the common structure may be a moveable platform mounted on a track or rail allowing both the door opener arm and the paint robot to travel simultaneously and in the same direction if required, and providing an axis of movement in addition to six axes of movement that may be provided by the robot.

One or more of the sensors or other units connected to the door opener arrangement may be equipped with a wireless transmitter. Wireless communications between for example the door sensor and a control unit of the robot process cell may be carried out using any suitable protocol. Suitably transmissions may be made using a short-range radio communication, such as a low-energy transmission conforming to a protocol compatible with any of: standards issued by the Bluetooth Special Interest Group (SIG); any variation of IEEE-802.11, WiFi, Ultra Wide Band (UWB), ZigBee or IEEE-802.15.4, IEEE-802.13 or equivalent or similar. A standard compatible with WAPI (WLAN Authentication and Privacy Infrastructure, GB15629.11-2003 or later) may advantageously be used in situations where encryption of the wireless signal is necessary or advantageous. Generally a radio technology working at high frequencies usually greater than 400 MHz, for example in the ISM band or higher, with significant interference suppression means by spread spectrum technology is the preferred type of wireless communication. For example a broad spectrum wireless protocol in which each or any data packet may be re-sent at other frequencies of a broad spectrum at around 7 times per millisecond, for example, may be used, such as in a protocol developed by ABB called Wireless interface for sensors and actuators (Wisa). Wireless communication may alternatively be carried out using Infra Red (IR) means and protocols such as IrDA, IrCOMM or similar. Wireless communication may also be carried out using sound or ultrasound transducers.

The door opener arrangement and door sensor may equally be used to detect other parts of a vehicle body to facilitate interior and/or exterior painting. Any part of a vehicle body may be sensed by the door sensor according to an embodiment of the present invention for the purposes of gripping and then opening/closing such parts such as a trunk lid, hood, fuel door, sunroof, cover part for a retractable soft-top roof, rear door, tailgate, hatchback and so on. Thus differently shaped or differently dimensioned parts intended for different vehicles, or different versions of the same type of automobile, eg 2 door vs 4 door, different back door/trunk lid shape for estate car or hatchback vs passenger car or coupe, may be accommodated automatically in the same production cell of a common production line or assembly area simply by means of changes in the door opener arrangement program(s) for a door opener arrangement 5a, 5b of one or more of the coating robots 8a, 8b. The value(s) in the control program for position of the door or doors, ie the desired position, is selected from a plurality of stored door positions which are known and predetermined for the doors of each type of vehicle or vehicle body variation.

One or more microprocessors (or processors or computers) comprise a central processing unit CPU performing the steps of the methods according to one or more aspects of the invention, as described for example with reference to FIGS. 7, 8, 2 and 5d. The method or methods are performed with the aid of one or more computer programs, which are stored at least in part in memory accessible by the one or more processors. It is to be understood that the computer programs for carrying out methods according to the invention may also be run on one or more general purpose industrial microprocessors or computers instead of one or more specially adapted computers or processors.

The computer program comprises computer program code elements or software code portions that make the computer or processor perform the methods using equations, algorithms, data, stored values, calculations and statistical or pattern recognition methods previously described, for example in relation to FIG. 2, 7, 8 or 5d. A part of the program may be stored in a processor as above, but also in a ROM, RAM, PROM, EPROM or EEPROM chip or similar memory means. The program in part or in whole may also be stored locally (or centrally) on, or in, other suitable computer readable medium such as a magnetic disk, CD-ROM or DVD disk, hard disk, magneto-optical memory storage means, in volatile memory, in flash memory, as firmware, or stored on a data server. Other known and suitable media, including removable memory media such as Sony memory stick (TM) and other removable flash memories, hard drives etc. may also be used. The program may also at least in part be supplied from a data network, including a public network such as the Internet.

The computer programs described may also be arranged at least in part as a distributed application capable of running on several different computers or computer systems at more or less the same time.

Methods of the invention may also be practised, especially for example during a configuration phase, or following a stoppage, or during normal operations by means of a Graphical User Interface (GUI), a graphical or textual display on an operator workstation, running on a user's logged-in computer, portable computer, combined mobile phone and computing device, or PDA etc, connected direct to the robot control system, or connected via a main or local control server, or other control unit even such as a simple controller or PLC, or via a control system computer/workstation.

It should be noted that while the above describes exemplifying embodiments of the invention, there are several variations and modifications which may be made to the disclosed solution without departing from the scope of the present invention as defined in the appended claims.

1. A door opener arrangement of a robot coating device for detecting a position of at least one door of a vehicle, said door opener arrangement comprising:
at least one first and non-contact sensor member, wherein said first sensor member is arranged mounted on a door opener arm of said door opener arrangement and wherein said first sensor member is arranged for determining a distance to said position of said at least one door.

2. The door opener arrangement according to claim 1, wherein the non-contact sensor member is arranged in a recess of the door opener arm or of a grip finger.

3. The door opener arrangement according to claim 1, wherein the non-contact sensor member is arranged inside a recess of the grip finger such that the sensor has a limited a field of view and a reduced exposure to the surroundings.

4. The door opener arrangement according to claim 1, further comprising:
at least one second sensor member for determining a deflection force applied to the door opener arrangement or to the door opener arm or to a part of the first sensor member.

5. The door opener arrangement according to claim 4, wherein the second member for determining a deflection force comprises an electromagnetic sensor.

6. The door opener arrangement according to claim 4, wherein the second member for determining a deflection force comprises a sensor which is any from the list of: strain gauge, optical, capacitive, inductive, magnetoelastic, soft sensor.

7. The door opener arrangement according to claim 4, wherein the second sensor member is arranged on the door opener arm for detecting a door position dependent on changes in a field strength of a magnetic or electromagnetic field in a z and vertical direction lying in a plane perpendicular to a direction of travel towards said part of a door dependent on mechanical deflection of the door opener arm.

8. The door opener arrangement according to claim 4, wherein a second sensor member is for detecting changes in a field strength of a magnetic or electromagnetic field in first and Y horizontal direction perpendicular to the first vertical direction.

9. The door opener arrangement according to claim 8, wherein two or more second sensor members are for measuring a deflection of the door opener arm in one or more horizontal directions.

10. The door opener arrangement according to claim 4, wherein a second sensor member is for measuring a deflection of the door opener arm in the vertical direction dependent on a deflection of one part of the door opener arrangement relative to another part of the door opener arrangement.

11. The door opener arrangement according to claim 4, wherein any of the second sensor members for detecting a deflection force on the door opener arm comprises a soft sensor for providing a calculated value for a deflection applied to the door opener arrangement.

12. The door opener arrangement according to claim 1, wherein the door opener arm is mounted on a moveable member which is arranged as a non-coating member or spray applicator.

13. The door opener arrangement according to claim 4, wherein at least one second sensor member is arranged to cooperate with a magnetic or ferromagnetic member attached to a part of the door opener arrangement.

14. The door opener arrangement according to claim 13, wherein at least one ferromagnetic member is mounted on the door opener arrangement with a magnetic surface flush with the surrounding adjacent part of the door opener arrangement.

15. The door opener arrangement according to claim 1, wherein said at least one non-contact sensor member is a member for detecting changes in a field strength of a magnetic or electromagnetic field.

16. The door opener arrangement according to claim 1, wherein said at least one non-contact sensor member comprises a sensor which is any from the list of: an ultrasound detector, a photoelectric, CCD, laser or IR other optical-based detector for detecting a distance to a position of at least one door.

17. A method for operating a robot coating process with at least one door opener arrangement for detecting a position of at least one door of a vehicle, the method comprising:
moving a non-contact sensor member of the door opener arrangement along a path toward said at least one door,
detecting a change in a value sensed in a first vertical direction,
detecting a maximum and/or minimum in signal strength dependent on a distance moved by the sensor member, and
determining a distance between a part of the door opener arrangement and a part of the vehicle.

18. The method according to claim 17, further comprising:
detecting the change in value of a magnetic or electromagnetic field in the proximity of said at least one door.

19. The method according to claim 17, further comprising:
determining a magnitude of an applied force or estimated applied force by means of one or more additional sensor members during a time when the non-contact sensor member is on a path toward, or away from, said door.

20. The method according to claim 19, further comprising:
determining a mechanical force applied to a sensor member along a horizontal and/or vertical direction lying a plane perpendicular to the path towards, or away from, said door.

21. The method according to claim 19, further comprising:
comparing the sensed or estimated mechanical force to a predetermined value and generating a control signal to insert a grip finger in said part of a door.

22. The method according to claim 21, further comprising:
generating an insertion movement of a grip finger in said part of a door and
generating a second control signal for the purpose of moving the door to a desired position.

23. The method according to claim 22, further comprising:
determining a magnitude of a mechanical force applied to the sensor member along a horizontal and/or vertical direction lying a plane perpendicular to the path towards said part of a door during the movement of the door to the desired position.

24. The method according to claim 23, further comprising:
comparing the magnitude of the sensed mechanical force during the movement of the door to the desired position to a predetermined value and
generating a control signal for control of the movement of the door dependent on the comparison of force values.

25. The method according to claim 17, further comprising:
providing a position of the door determined by the door opener to a control unit of a robot for the purpose of controlling an operation of the robot.

26. The method according to claim 22, further comprising:
selecting a value for the desired position of the door dependent on a predetermined type of vehicle to be coated.

27. A computer program product, comprising:
a computer readable medium and
computer program instructions recorded on the computer readable medium and executable by a computer or processor to carry out a method comprising
moving a non-contact sensor member of the door opener arrangement along a path toward said at least one door,
detecting a change in a value sensed in a first vertical direction,
detecting a maximum and/or minimum in signal strength dependent on a distance moved by the sensor member, and
determining a distance between a part of the door opener arrangement and a part of the vehicle.

28. (canceled)

29. A system for robot coating of vehicles, comprising:
a robot for coating, and
a door opener arrangement for detecting a position of at least one door of a vehicle, said door opener arrangement including at least one first and non-contact sensor member, wherein said at least one non-contact sensor member is arranged for determining a distance to said position of said at least one door and comprising at least one door opener arrangement with at least one second sensor member for determining a deflection force applied to the door opener arrangement or to the door opener arm or to a part of the first sensor member.

30. The system according to claim 29, wherein a plurality of sensors arranged for measuring a force applied to the door sensor or the door opener arm or assembly on which the door sensor is arranged.

31. The system according to claim 29, wherein one or more sensor members for detecting a deflection force on the door opener arm comprises a soft sensor for providing a calculated value for a deflection applied to the door opener arrangement or of the door opener arrangement.

32. The system according to claim 29, further comprising:
at least two manipulator arms arranged to process the same object or part thereof.

33. The system according to claim 29, further comprising:
a computer program product comprising a computer readable medium and computer program instructions recorded on the computer readable medium and executable by a computer or processor to carry out a method comprising moving a non-contact sensor member of the door opener arrangement along a path toward said at least one door, detecting a change in a value sensed in a first vertical direction, detecting a maximum and/or minimum in signal strength dependent on a distance moved by the sensor member, and determining a distance between a part of the door opener arrangement and a part of the vehicle.

34. Use of a door opener arrangement according to claim 1 for coating a part of a vehicle interior and/or a vehicle exterior with a painting robot or a reciprocator.

35. Use of a door opener arrangement according to claim 1 for determining for the purpose of coating a vehicle interior and/or exterior a position on a vehicle of from the list of: window, door, trunk lid, hood, hatch, roof cover, fuel door.
